(19) United States
(12) Patent Application Publication
(10) Pub. No.: US 2006/0225079 A1
(43) Pub. Date: Oct. 5, 2006

(54) Normalized measurement of computer resource usage

(76) Inventors: Ranjit K. Nayak, Austin, TX (US); Sridhar Sudarsan, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/095,733

(22) Filed: Mar. 31, 2005

(51) Int. Cl. G06F 9/46

(52) U.S. Cl. 718/105

(57) ABSTRACT

Exemplary methods, systems, and products are described for normalized measurement of computer resource usage by use of benchmarks of performance that reduce the complexity of calculating customer charges for use of computer resources in a hosted environment. More particularly, exemplary methods, systems, and products are described for normalized measurement of computer resource usage that include calculating a normalization coefficient for a computer resource of a type, measuring actual usage of the resource by a user, and calculating normalized usage in dependence upon the normalization coefficient and the actual usage. Calculating a normalization coefficient is typically carried out in dependence upon a benchmark value for the computer resource and upon benchmark values for a multiplicity of computer resources of the type.

### BACKGROUND OF THE INVENTION

1. Field of the Invention

The field of the invention is data processing, or, more specifically, methods, systems, and products for normalized measurement of computer resource usage.

2. Description of Related Art

Data centers or hosting service providers (which for convenience are referred to generally in this specification as ‘hosted environments’) typically host several or even many applications and customers who use make online use of those applications. Such hosted environments are typically implemented in distributed computing technologies in which a user's thread of execution may run now on one processor in one kind of computer system, later on another processor on another kind of system, and so on. A customer may run hundreds or thousands or more threads during a billing period on dozens or hundreds of different kinds of computer resources, each of which may have a different billing rate and a different unit of measurement of usage. In such environments, there is no standard way to normalize measurements of computer resource usage so as to reduce the computational burden of calculating charges to customers for use of computer resources in the environment.

### SUMMARY OF THE INVENTION

Exemplary methods, systems, and products are described for normalized measurement of computer resource usage by use of benchmarks of performance that reduce the complexity of calculating customer charges for use of computer resources in a hosted environment. More particularly, exemplary methods, systems, and products are described for normalized measurement of computer resource usage that include calculating a normalization coefficient for a computer resource of a type, measuring actual usage of the resource by a user, and calculating normalized usage in dependence upon the normalization coefficient and the actual usage. Calculating a normalization coefficient is typically carried out in dependence upon a benchmark value for the computer resource and upon benchmark values for a multiplicity of computer resources of the type.

Calculating a normalization coefficient may include dividing a benchmark value for the computer resource by an average benchmark value for a multiplicity of computer resources of the type. Calculating normalized usage in dependence upon the normalization coefficient and the actual usage may be carried out by multiplying the actual usage by the normalization coefficient.

Calculating a normalization coefficient may include measuring in a hosted environment a benchmark value for the computer resource. Calculating a normalization coefficient may include acquiring a benchmark value for the computer resource from an industry-standard source. Calculating a normalization coefficient may include measuring in a hosted environment benchmark values for a multiplicity of computer resources of the type. Calculating a normalization coefficient may include acquiring benchmark values for a multiplicity of computer resources of the type from an industry-standard source.

Measuring actual usage may be carried out by sampling values of actual usage. Measuring actual usage may include sampling values of actual usage periodically for a period of time. Measuring actual usage may include sampling values of actual usage periodically for a period of time and averaging the sampled values. Embodiments may include calculating a charge to the user in dependence upon the normalized usage. Embodiments may also include a user's using a multiplicity of computer resources of the type and calculating a charge to the user with a single billing rate for all the computer resources of the type.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for normalized measurement of computer resource usage according to embodiments of the present invention.

FIG. 2 sets forth a block diagram of automated computing machinery comprising an exemplary computer useful in a hosted environment for normalized measurement of computer resource usage according to embodiments of the present invention.

FIG. 3 sets forth a flow chart illustrating an exemplary method for normalized measurement of computer resource usage according to embodiments of the present invention.

FIG. 4 sets forth a table illustrating exemplary relations among benchmark values for computer resources, normalization coefficients for the computer resources, and normalized benchmark values.

### DETAILED DESCRIPTION OF EXEMPLARY EMBODIMENTS

### Introduction

The present invention is described to a large extent in this specification in terms of methods for normalized measurement of computer resource usage. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Normalized Measurement of Computer Resource Usage

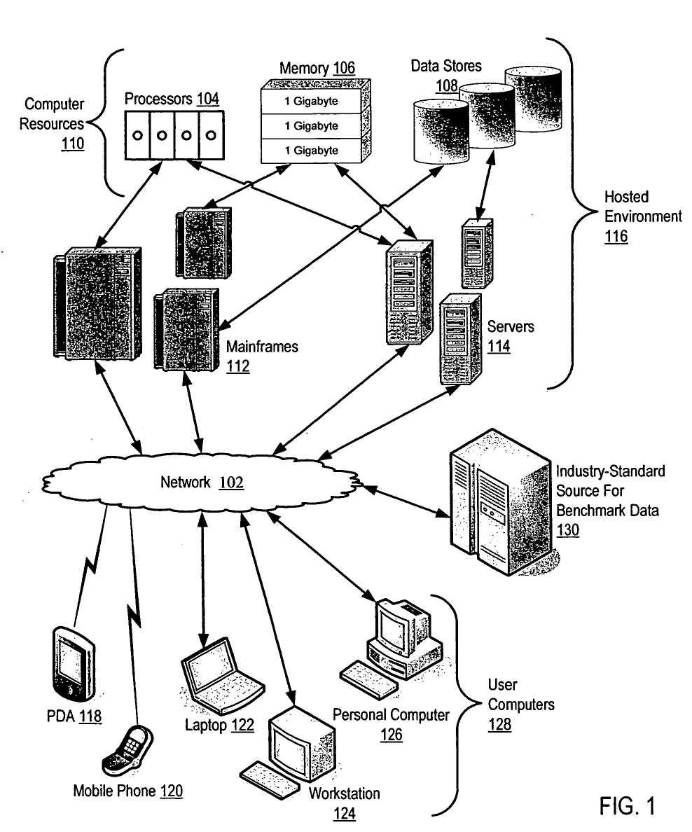

Exemplary methods, systems, and products for normalized measurement of computer resource usage according to embodiments of the present invention are described with reference to the accompanying drawings, beginning with FIG. 1. FIG. 1 sets forth a network diagram illustrating an exemplary system for normalized measurement of computer resource usage according to embodiments of the present invention. The system of FIG. 1 includes a hosted environment (116) made up of mainframe computers (112) and servers (114) that host computer applications on behalf of customers who own and operate user computers (128) connect to the hosted environment through network (102) to obtain services from hosted applications. Hosted applications utilize computer resources (110) of the hosted environment, and the owner or operator of the hosted environment charges the customers for such usage.

Types of computer resources so used by hosted applications include any computer resource for which usage can be measured, including, for example, processors (104), memory (106), input/output capacity, data stores (108), database metrics, additional licensed users, operating system modules, application programs, and so on as will occur to those of skill in the art. Types of user computers to which hosted services are provided may include any computing device capable of data communications with the hosted environment, including, for example, personal computers (126), computer workstations (124), laptops (122), mobile telephones (120), and personal digital assistants (120).

The system of FIG. 1 operates generally to normalize measurement of computer resource usage according to embodiments of the present invention by calculating a normalization coefficient for a computer resource of a type, measuring actual usage of the resource by a user, and calculating normalized usage in dependence upon the normalization coefficient and the actual usage. In the system of FIG. 1, calculating a normalization coefficient is carried out in dependence upon a benchmark value for the computer resource and upon benchmark values for a multiplicity of computer resources of the type. Such benchmark values may be calculated in the hosted environment itself (116) (by running benchmark applications there, for example), by acquiring them from an industry-standard source (130) (downloaded through network (102), for example), or otherwise as will occur to those of skill in the art.

Benchmarks useful for normalization of measurement of computer resource usage according to embodiments of the present invention include any measure of performance of computer resources. In the case of processor performance, for example, useful benchmarks are available online from the System Performance Evaluation Corporation (‘SPEC’). SPEC is a performance standardization organization with more than 60 member companies. SPEC publishes several hundred different performance results each quarter spanning across a variety of system performance disciplines. SPEC's processor benchmarks include a benchmark named ‘CINT2000’ that includes a dozen intensive integer calculation applications, such as, for example, a data compression application, a circuit placement and routing application, a C programming language compiler, a combinatorial optimization application, a chess playing application, and so on. To calculate a CINT2000 benchmark value for a processor, all the applications comprising the benchmark are run on the processors, their times to run are measured, and the geometric mean of their run times is calculated as the CINT2000 benchmark value for the processor.

In addition to CINT2000, SPEC also provides benchmarks for floating point performance, graphics performance, parallel architecture performance, Java™ client/server performance, network file system performance, email server performance, and web server performance. In addition, SPEC makes available online downloads of reported benchmark measures of many different kinds of computer resources. The SPEC benchmarks and benchmark values available through SPEC are described here only as examples of benchmarks and benchmark values available from an industry-standard source for benchmark data, not as limitations of the present invention. It is well within the scope of the invention to use any benchmark for a computer resource and any pertinent benchmark data for normalizing measurement of computer resource usage.

The arrangement of mainframes, servers, user computers, network, and other devices making up the exemplary system illustrated in FIG. 1 are for explanation, not for limitation. Data processing systems useful according to various embodiments of the present invention for normalized measurement of computer resource usage may include additional servers, routers, other devices, client-server and peer-to-peer architectures, not shown in FIG. 1, as will occur to those of skill in the art. Networks in such data processing systems may support many data communications protocols, including for example TCP/IP, HTTP, WAP, HDTP, and others as will occur to those of skill in the art. Various embodiments of the present invention may be implemented on a variety of hardware platforms in addition to those illustrated in FIG. 1.

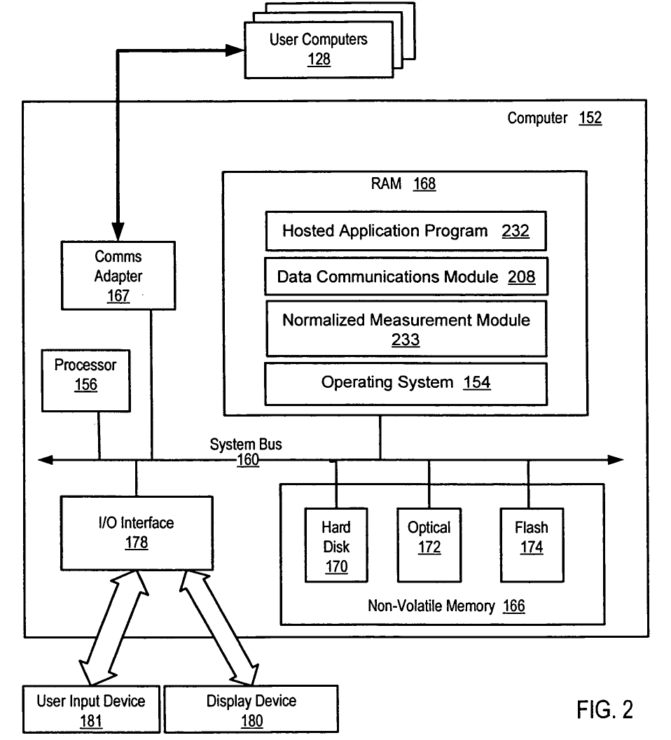

Normalized measurement of computer resource usage in accordance with the present invention is generally implemented with computers, that is, with automated computing machinery. In the system of FIG. 1, for example, all the mainframes, servers, and user computers, as well as the industry-standard source for benchmark data are implemented, to some extent at least, as computers. For further explanation, therefore, FIG. 2 sets forth a block diagram of automated computing machinery comprising an exemplary computer (152) useful in a hosted environment for normalized measurement of computer resource usage according to embodiments of the present invention. The computer (152) of FIG. 2 includes at least one computer processor (156) or ‘CPU’ as well as random access memory (168) (“RAM”) which is connected through a system bus (160) to processor (156) and to other components of the computer.

Stored in RAM (168) is a hosted application program (232). Hosted application program (232) is made up of computer program instructions capable of providing any number of services to customers of a hosted environment, including, for example, accounting, information retrieval from databases, word processing, email delivery, web site hosting, and others as will occur to those of skill in the art. Also stored RAM (168) is a data communications module (208), computer program instructions capable of operating communications adapter (167) to provide data communications between hosted application program (232) and user computers (128). Also stored in RAM (168) is a normalized measurement module (233), a set of computer program instructions for normalized measurement of computer resource usage according to embodiments of the present invention.

Also stored in RAM (168) is an operating system (154). Operating systems useful in computers according to embodiments of the present invention include UNIX™, Linux™, Microsoft NT™, AIX™, IBM's i5/OS, and many others as will occur to those of skill in the art. Operating system (154), hosted application program (232), data communications module (208), and normalized measurement module (233) in the example of FIG. 2 are shown in RAM (168), but many components of such software typically are stored in non-volatile memory (166) also.

Computer (152) of FIG. 2 includes non-volatile computer memory (166) coupled through system bus (160) to processor (156) and to other components of computer (152). Non-volatile computer memory (166) may be implemented as a hard disk drive (170), optical disk drive (172), electrically erasable programmable read-only memory space (so-called ‘EEPROM’ or ‘Flash’ memory) (174), or as any other kind of computer memory as will occur to those of skill in the art. The example computer of FIG. 2 also includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) user other computers (182). Such data communications may be carried out through serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for normalized measurement of computer resource utilization according to embodiments of the present invention include modems for wired dial-up communications, Ethernet (IEEE 802.3) adapters for wired network communications, and 802.11b adapters for wireless network communications.

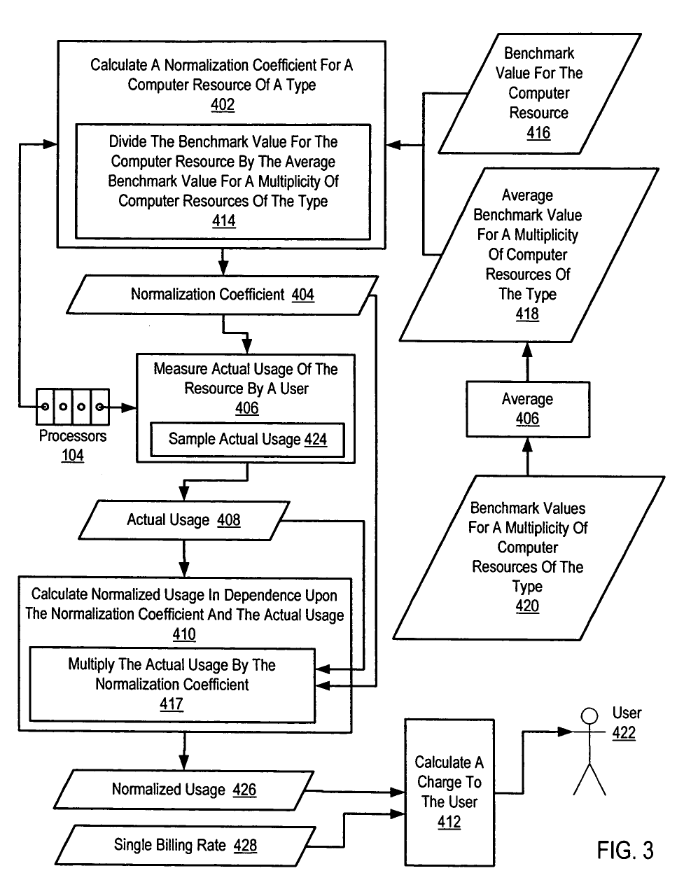

For further explanation, FIG. 3 sets forth a flow chart illustrating an exemplary method for normalized measurement of computer resource usage according to embodiments of the present invention that includes calculating (402) a normalization coefficient (404) for a computer resource (104) of a type (here exemplified as several processors), measuring (406) actual usage (408) of the resource by a user; and calculating (410) normalized usage in dependence upon the normalization coefficient (404) and the actual usage (408). In the particular example of FIG. 3, the resource type is illustrated as processors (104), although the method of FIG. 3 can be applied to any resource type, memory, I/O capacity, database metrics, and so on, as will occur to those of skill in the art.

In the method of FIG. 3, calculating (402) a normalization coefficient is carried out in dependence upon a benchmark value (416) for the computer resource and also in dependence upon benchmark values (420) for a multiplicity of computer resources of the type. The dependency upon benchmark values (420) for a multiplicity of computer resources of the type is by use of an average (406). That is, in the method of FIG. 3, calculating (402) a normalization coefficient (404) is carried out by dividing (414) a benchmark value (416) for the computer resource (a processor, in this example) by an average benchmark value (418) for a multiplicity of computer resources of the type (the type being ‘processors,’ in this example). Consider, for example, a processor having a benchmark value of 1583 and a set of processors having an average value for the same benchmark of 1410. A normalization coefficient for the processor then may be calculated as 1583÷1410=1.12.

In the method of FIG. 3, calculating (402) a normalization coefficient (404) may include measuring in a hosted environment a benchmark value for the computer resource or acquiring a benchmark value for the computer resource from an industry-standard source. That is, the benchmark value for the computer resource under consideration may be measured in a hosted environment where normalized measurement of computer resource usage is carried out according to embodiments of the present invention. Or, alternatively, the benchmark value for the computer resource under consideration may be downloaded from an industry-standard source of such benchmark data. Other alternative ways of acquiring or a developing benchmark value for a computer resource may occur to those of skill in the art, and all such ways are well within the scope of the present invention.

In the method of FIG. 3, calculating (402) a normalization coefficient (404) may include measuring in a hosted environment benchmark values for a multiplicity of computer resources of the type or acquiring benchmark values for a multiplicity of computer resources of the type from an industry-standard source. That is, the benchmark values for a multiplicity of computer resources of the type of computer resource under consideration may be measured in a hosted environment where normalized measurement of computer resource usage is carried out according to embodiments of the present invention. Or, alternatively, the benchmark values for a multiplicity of computer resources of the type of computer resource under consideration may be downloaded from an industry-standard source of such benchmark data. Other alternative ways of acquiring or developing benchmark values for a multiplicity of computer resources of a type may occur to those of skill in the art, and all such ways are well within the scope of the present invention.

In the method of FIG. 3, measuring actual usage (406) may include sampling (424) values of actual usage. In the method of FIG. 3, measuring actual usage may include sampling values of actual usage periodically for a period of time. In the method of FIG. 3, measuring actual usage may include sampling values of actual usage periodically for a period of time and averaging the sampled values.

A units of data processing is typically referred to as a ‘process’ or a ‘thread.’ Systems that normalize measurement of computer resource usage according to embodiments of the present invention typically include an operating system that administers data structures representing each process or thread of execution running on the system. Each such data structure is called a Process Control Block (‘PCB’) or a Thread Control Block (‘TCB’). A process typically contains a multiplicity of threads; this specification, therefore, with no reduction its generality, discusses these data structures in terms of TCBs.

A system that normalizes measurement of computer resource usage according to embodiments of the present invention typically maintains resource utilization statistics stored in a TCB describing resource utilization by each thread running on the system. Examples of such statistics include the amount of processor time used while executing instructions of a thread, the amount of processor time used while executing operating system instructions on behalf of the thread, and the sum of these times for the thread. Such statistics represent values of actual usage of computer resources. Sampling such statistics allows a normalized measurement module according to embodiments of the present invention to measure actual usage of a computer resource by a user; the user being represented in this example by a thread of execution. If, for example, periodic sampling indicates that a thread representing a user actually uses thirty seconds of processor time during a one-minute period of sampling, then the user's actual usage of the processor may be expressed as 50% utilization.

In the method of FIG. 3, calculating (410) normalized usage (426) in dependence upon the normalization coefficient (404) and the actual usage (408) includes multiplying (417) the actual usage (408) by the normalization coefficient (404). Consider again, for example, a processor having a benchmark value of 1583 and an actual usage of 50% by a user thread of execution. In this example, a set of processors has an average value for the same benchmark of 1410. A normalization coefficient for the processor is calculated as 1583÷1410=1.12, and a normalized usage of the processor by the thread is calculated as 50×1.12=56.15.

The method of FIG. 3 includes calculating (412) a charge to the user (422) in dependence upon the normalized usage (426). When a user uses a multiplicity of computer resources of the type, the method of FIG. 3 may include calculating (412) a charge to the user with a single billing rate (428) for all the computer resources of the type.

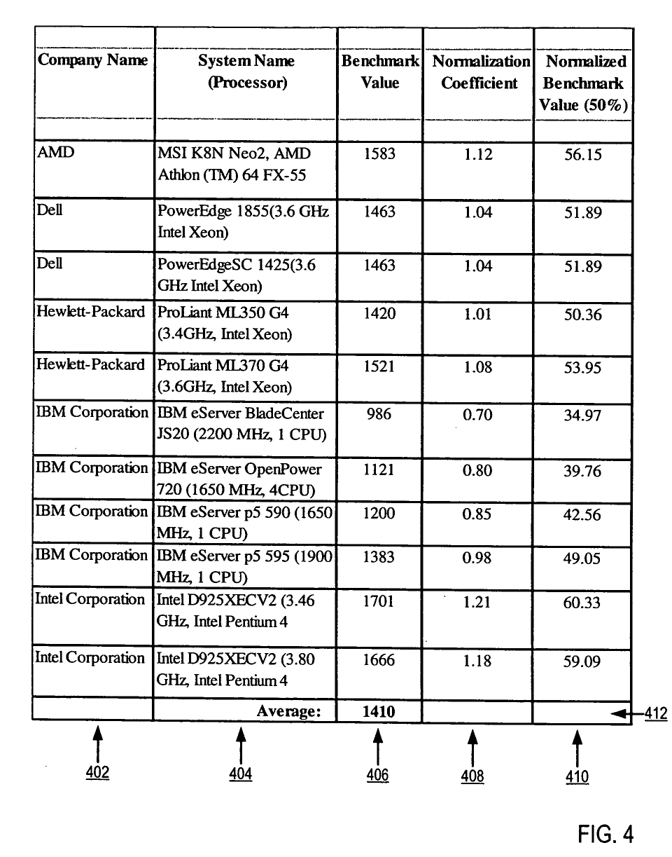

For further explanation, FIG. 4 sets forth a table illustrating exemplary relations among benchmark values (406) for computer resources, normalization coefficients (408) for the computer resources, and normalized benchmark values (410). In the table of FIG. 4, the exemplary computer resources are computer processors, and each row in the table sets forth information for a different processor. Column (402) identifies the manufacturer of each processor.

Column (404), labeled “System Name (Processor),” identifies a processor and the system configuration in which the processor was tested to generate the benchmark values in column (406). An average value (412) for all the benchmark values for all the processors is set forth at the bottom of column (406). Each normalization value (408) is related to its corresponding benchmark value as the quotient of the benchmark value divided by the average benchmark value of all the processors. That is:
the normalization coefficient of 1.12 for the AMD Athlon processor is the quotient of 1583 divided by 1410,
the normalization coefficient of 1.04 for the Intel Xeon processor running in the Dell PowerEdge 1855 is the quotient of 1463 divided by 1410,
the normalization coefficient of 1.0212 for the Intel Xeon processor running in the HP ProLiant ML350 G4 is the quotient of 1420 divided by 1410,
the normalization coefficient of 0.70 for the processor running in the IBM eServer BladeCenter JS 20 is the quotient of 986 divided by 1410,
and soon . . .

In this example, for purposes of explanation, normalized benchmark values (410) are illustrated on the assumption of 50% actual usage of a processor by a user thread. Each normalized benchmark value (410) is the product of the corresponding normalization coefficient (408) for a processor multiplied by an actual usage for the processor, taken in this case for purposes of explanation to be a 50% actual utilization rate. That is:
the normalized benchmark value of 56.15 for the AMD Athlon processor expresses a normalized percentage of utilization that is the product of 1.12 multiplied by 50%,
the normalized benchmark value of 51.89 for the Intel Xeon processor running in the Dell PowerEdge 1855 expresses a normalized percentage of utilization that is the product of 1.04 multiplied by 50%,
the normalized benchmark value of 50.36 for the Intel Xeon processor running in the HP ProLiant ML350 G4 expresses a normalized percentage of utilization that is the product of 1.01 multiplied by 50%,
the normalized benchmark value of 34.97 for the processor running in the IBM eServer BladeCenter JS 20 expresses a normalized percentage of utilization that is the product of 0.70 multiplied by 50%,
and so on . . .

Readers will understand in view of the explanations set forth above in this specification that in systems that normalize measurement of computer resource usage according to embodiments of the present invention a single billing rate may be used by a hosting environment to charge all users for all usage of all the processors in the hosted environment because all usage can be normalized as described. It will be understood from the foregoing description also that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for normalized measurement of computer resource usage, the method comprising:
calculating a normalization coefficient for a computer resource of a type;
measuring actual usage of the resource by a user; and
calculating normalized usage in dependence upon the normalization coefficient and the actual usage.

2. The method of claim 1 wherein calculating a normalization coefficient further comprises calculating a normalization coefficient in dependence upon a benchmark value for the computer resource and upon benchmark values for a multiplicity of computer resources of the type.

3. The method of claim 1 wherein calculating a normalization coefficient further comprises dividing a benchmark value for the computer resource by an average benchmark value for a multiplicity of computer resources of the type.

4. The method of claim 1 wherein calculating normalized usage in dependence upon the normalization coefficient and the actual usage further comprises multiplying the actual usage by the normalization coefficient.

5. The method of claim 1 wherein measuring actual usage further comprises sampling values of actual usage.

6. The method of claim 1 wherein measuring actual usage further comprises sampling values of actual usage periodically for a period of time.

7. The method of claim 1 wherein measuring actual usage further comprises:
sampling values of actual usage periodically for a period of time; and
averaging the sampled values.

8. The method of claim 1 further comprising calculating a charge to the user in dependence upon the normalized usage.

9. The method of claim 1 further comprising:
the user's using a multiplicity of computer resources of the type; and
calculating a charge to the user with a single billing rate for all the computer resources of the type.

10. The method of claim 1 wherein calculating a normalization coefficient further comprises measuring in a hosted environment a benchmark value for the computer resource.

11. The method of claim 1 wherein calculating a normalization coefficient further comprises acquiring a benchmark value for the computer resource from an industry-standard source.

12. The method of claim 1 wherein calculating a normalization coefficient further comprises measuring in a hosted environment benchmark values for a multiplicity of computer resources of the type.

13. The method of claim 1 wherein calculating a normalization coefficient further comprises acquiring benchmark values for a multiplicity of computer resources of the type from an industry-standard source.

14. A system for normalized measurement of computer resource usage, the system comprising:
a computer processor; and
a computer memory operatively coupled to the computer processor and having disposed within the computer memory computer program instructions capable of:
calculating a normalization coefficient for a computer resource of a type;
measuring actual usage of the resource by a user; and
calculating normalized usage in dependence upon the normalization coefficient and the actual usage.

15. The system of claim 14 wherein calculating a normalization coefficient further comprises calculating a normalization coefficient in dependence upon a benchmark value for the computer resource and upon benchmark values for a multiplicity of computer resources of the type.

16. The system of claim 14 wherein calculating a normalization coefficient further comprises dividing a benchmark value for the computer resource by an average benchmark value for a multiplicity of computer resources of the type.

17. The system of claim 14 wherein calculating normalized usage in dependence upon the normalization coefficient and the actual usage further comprises multiplying the actual usage by the normalization coefficient.

18. The system of claim 14 wherein measuring actual usage further comprises sampling values of actual usage.

19. The system of claim 14 wherein measuring actual usage further comprises sampling values of actual usage periodically for a period of time.

20. The system of claim 14 wherein measuring actual usage further comprises:
sampling values of actual usage periodically for a period of time; and
averaging the sampled values.

21. The system of claim 14 further comprising calculating a charge to the user in dependence upon the normalized usage.

22. The system of claim 14 wherein the computer program instructions have the further capabilities of:
supporting the user's use of a multiplicity of computer resources of the type; and
calculating a charge to the user with a single billing rate for all the computer resources of the type.

23. The system of claim 14 wherein calculating a normalization coefficient further comprises measuring in a hosted environment a benchmark value for the computer resource.

24. The system of claim 14 wherein calculating a normalization coefficient further comprises acquiring a benchmark value for the computer resource from an industry-standard source.

25. The system of claim 14 wherein calculating a normalization coefficient further comprises measuring in a hosted environment benchmark values for a multiplicity of computer resources of the type.

26. The system of claim 14 wherein calculating a normalization coefficient further comprises acquiring benchmark values for a multiplicity of computer resources of the type from an industry-standard source.

27. A computer program product for normalized measurement of computer resource usage, the computer program product comprising:
a recording medium;
means, recorded on the recording medium, for calculating a normalization coefficient for a computer resource of a type;
means, recorded on the recording medium, for measuring actual usage of the resource by a user; and
means, recorded on the recording medium, for calculating normalized usage in dependence upon the normalization coefficient and the actual usage.

28. The computer program product of claim 27 wherein means, recorded on the recording medium, for calculating a normalization coefficient further comprises means, recorded on the recording medium, for calculating a normalization coefficient in dependence upon a benchmark value for the computer resource and upon benchmark values for a multiplicity of computer resources of the type.

29. The computer program product of claim 27 wherein means, recorded on the recording medium, for calculating a normalization coefficient further comprises means, recorded on the recording medium, for dividing a benchmark value for the computer resource by an average benchmark value for a multiplicity of computer resources of the type.

30. The computer program product of claim 27 wherein means, recorded on the recording medium, for calculating normalized usage in dependence upon the normalization coefficient and the actual usage further comprises means, recorded on the recording medium, for multiplying the actual usage by the normalization coefficient.

31. The computer program product of claim 27 wherein means, recorded on the recording medium, for measuring actual usage further comprises means, recorded on the recording medium, for sampling values of actual usage.

32. The computer program product of claim 27 wherein means, recorded on the recording medium, for measuring actual usage further comprises means, recorded on the recording medium, for sampling values of actual usage periodically for a period of time.

33. The computer program product of claim 27 wherein means, recorded on the recording medium, for measuring actual usage further comprises:
means, recorded on the recording medium, for sampling values of actual usage periodically for a period of time; and
means, recorded on the recording medium, for averaging the sampled values.

34. The computer program product of claim 27 further comprising means, recorded on the recording medium, for calculating a charge to the user in dependence upon the normalized usage.

35. The computer program product of claim 27 further comprising:
means, recorded on the recording medium, for using by a user of a multiplicity of computer resources of the type; and
means, recorded on the recording medium, for calculating a charge to the user with a single billing rate for all the computer resources of the type.

36. The computer program product of claim 27 wherein means, recorded on the recording medium, for calculating a normalization coefficient further comprises means, recorded on the recording medium, for measuring in a hosted environment a benchmark value for the computer resource.

37. The computer program product of claim 27 wherein means, recorded on the recording medium, for calculating a normalization coefficient further comprises means, recorded on the recording medium, for acquiring a benchmark value for the computer resource from an industry-standard source.

38. The computer program product of claim 27 wherein means, recorded on the recording medium, for calculating a normalization coefficient further comprises means, recorded on the recording medium, for measuring in a hosted environment benchmark values for a multiplicity of computer resources of the type.

39. The computer program product of claim 27 wherein means, recorded on the recording medium, for calculating a normalization coefficient further comprises means, recorded on the recording medium, for acquiring benchmark values for a multiplicity of computer resources of the type from an industry-standard source.
